(19) United States
(12) Patent Application Publication
(10) Pub. No.: US 2026/0099229 A1
(43) Pub. Date: Apr. 9, 2026

(54) ELECTRONIC WHITEBOARD WITH IMPROVED WRITING RECOGNITION PERFORMANCE

(71) Applicant: Daelim System Co., Ltd., Incheon (KR)

(72) Inventors: Jun Seok LEE, Incheon (KR); Jung Eun LEE, Seoul (KR); Soon Boo CHANG, Seoul (KR)

(73) Assignee: Daelim System Co., Ltd., Incheon (KR)

(21) Appl. No.: 19/087,016

(22) Filed: Mar. 21, 2025

(30) Foreign Application Priority Data
Oct. 7, 2024 (KR) 10-2024-0135633

(51) Int. Cl. G06F 3/042; G06F 3/041

(52) U.S. Cl. CPC G06F 3/0421; G06F 3/0412

(57) ABSTRACT

Disclosed is an electronic whiteboard which improves writing recognition of an optical touch panel and an operating method thereof and an object is to provide an optical electronic whiteboard which precisely identifies an object and a touch position of the object by overcoming a physical limit such as a size of a light emitting element on a touch screen which uses a light beam touch panel and an operating method thereof.

### CROSS-REFERENCE TO RELATED APPLICATIONS

This application claims the priority of Korean Patent Application No. 10-2024-0135633 filed on Oct. 7, 2024, in the Korean Intellectual Property Office, the disclosure of which is incorporated herein by reference.

### BACKGROUND

### Field

The present disclosure relates to an electronic whiteboard with an improved writing recognition performance of an optical touch panel and an operating method thereof, and more particularly, to an electronic whiteboard with an improved writing recognition performance which includes IR emitting and receiving sensors on a top/bottom and left/right of a touch panel, differentiates a wavelength and a phase of each IR, and processes a variance of a path and a light amount of each of two or more identified distinguished IRs to determine a touch coordinate and an operating method thereof.

### Description of the Related Art

An electronic whiteboard refers to a device which allows a user to directly input contents to be displayed on a screen by touching a touch panel coupled with a screen with an object such as a touch pen or a finger and a size has been gradually increasing in recent years.

A touch panel of the electronic whiteboard includes a sensor to recognize a touch using an object. In order to solve the problems of recognition rate and a writing feel, which are pointed out as shortcomings of a pressure sensitive touch panel, electronic whiteboards which employ electrostatic touch panels or optical touch panels are mainly used.

Generally, in the case of the optical touch panel, according to a method for determining a writing position, a light beam irradiated from a light emitting element of a light transmitting unit is sensed in a one-to-one correspondence with a light beam receiving sensor of a light receiving unit to determine a writing position and a light transmitting unit and a reception sensor are densely disposed on top/bottom and left/right sides of a display to configure a matrix with the light beam to sense an XY coordinate of a contact object. In the case of the electronic whiteboard which employs a touch method using a light beam in the recent years, multi-point input is possible to support swipe control or pinch zoom function.

According to this technique, a light beam irradiated from the light emitting element is sensed in a one-to-one correspondence with a light beam sensing sensor of a light receiving unit to determine a writing position so that an area where the light beam sensing sensor senses the light beam irradiated from the light emitting element may be limited by physical sizes of the light emitting element and the light beam sensing sensor. Accordingly, there is a problem in that in an area in which the light beam is not transmitted to the light beam sensing sensor from the light emitting element, that is, an area where the writing position cannot be determined, the writing position may be not determined.

In order to solve the above-mentioned problem, in Korean Registered Patent Publication No. 10-1890695, a technique that the number of light beam receiving sensors which receive and process light beam irradiated from one light emitting element is increased to reduce a part where the writing is not recognized to improve the writing recognition rate has been disclosed. However, there are still limitations in accurately recognizing an object or accurately displaying a written content of the object.

Further, Korean Registered Patent No. 10-2446679 discloses a technique that multi-touch input is possible while recognizing touch based on a light beam. However, according to this technique, a plurality of sensing optical sensors which includes at least two types of light emitting elements and is configured to identify two types of light beams confirms light beam sensing data from which a light beam amount is measured as an initial state in which an object is not sensed and two or more sensing optical sensors which sense change in the light amount when a change in a light amount is confirmed from at least a part of light beam amount in the initial state.

However, this disclosure also has a limitation in increasing precision because the interval of the light beams cannot be precisely configured due to the structure of the light emitting element and has a problem in that many calculations are required to determine a touched touch coordinate due to light beams which interfere with each other.

### PRIOR ARTS

### Patent Documents

(Patent Document 1) Korean Registered Patent Publication No. 10-1890695 B1 (Published on Aug. 16, 2018)

(Patent Document 2) Korean Registered Patent Publication No. 10-2446679 B1 (Published on Sep. 20, 2022)

### SUMMARY

The present disclosure has been made to solve the above-described problems and an object of the present disclosure is to provide an optical electronic whiteboard which precisely identifies an object and a touch position of the object by overcoming a physical limit, such as a size of a light emitting element on a touch screen which uses a light beam touch panel and an operating method thereof.

An object is to provide an optical electronic whiteboard which overcomes a physical limit such as sizes of a light emitting element and a receiving element by processing a variance of a path and a light amount of each of two or more infrared rays to improve a touch recognition accuracy and an operating method thereof.

Still another object of the present disclosure is to provide an electronic whiteboard which determines a position of an object using a plurality of light beams emitted from one light emitting element or a group of two or more light emitting elements, rather than determining a position of an object with one light emitting element and one sensing optical sensor, to not only precisely determine a touch coordinate of the object, but also precisely and accurately identify a touch position according to a movement of an object and an operating method thereof.

Objects to be achieved by various exemplary embodiments of the present disclosure are not limited to the above-mentioned problems, and other objects, which are not mentioned above, can be clearly understood by those skilled in the art from the following descriptions.

In order to achieve the above-described object and remove the drawback of the related art, an electronic whiteboard with an improved writing recognition performance of the present disclosure is an electronic whiteboard including a light processing unit which recognizes a coordinate of an object from sensed sensing data and a screen which visually displays a content generated based on a recognized coordinate of the object. The light processing unit includes: a light transmitting unit including a plurality of light emitting elements installed on the screen; and a light receiving unit including a plurality of sensing optical sensors which is installed in a position corresponding to the light transmitting unit to receive a light beam emitted from the light emitting elements, the light transmitting unit includes a light emitting element which emits a light beam and an optical path converter which is installed on a front surface portion of the light emitting element to convert a direction of a light beam emitted from the light emitting element, and the optical path converter is a prism sheet in which a trapezoidal prism pattern is formed and converts a direction of a light beam emitted from the light emitting element to a plurality of directions.

The prism pattern includes a support film and a larger surface of a trapezoid is disposed to be closer to the light emitting element and a smaller surface is disposed at the outside.

A pitch of the prism pattern is 0.5 times or less than a length of the light emitting element and an inclined surface of the trapezoid of the prism pattern is 45° to 60°.

The optical path converter is attached to a surface of a transparent support and a thin light absorption film is formed on an inclined surface of the trapezoidal side surface of the prism pattern.

Desirably, the optical path converter is a laminated prism sheet with a double-layered structure in which an upper prism sheet having a first pattern in a first direction on one surface and a lower prism sheet having a second pattern in a second direction on one surface are coupled with an adhesive layer therebetween.

Desirably, the optical path converter is a hybrid prism sheet with a hybrid structure in which an upper prism sheet having a first pattern in a first direction on one surface and a lower prism sheet having a second pattern in a second direction on one surface are overlaid to have a plurality of patterns with quadrangular shapes with trapezoidal surfaces, the first direction and the second direction are different directions and two directions are perpendicular to each other.

Desirably, the prism pattern is formed by applying an UV curable resin solution resin to one surface of a support film which is formed of at least one of polyethylene terephthalate or polyethylene naphthalate, which is a transparent material to transmit light and irradiating light to cure the resin.

Desirably, the light transmitting unit includes an optical filter which filters a direction of a light beam.

According to various exemplary embodiments of the present disclosure, wavelengths and phases of light beams which are emitted from light emitting elements which configure a light beam touch panel are set to be different from each other so that when a touch coordinate of an object touched on the touch panel is determined, a determination error due to interference of the light beam may be reduced and an accuracy of an operation of determining a touch coordinate may be improved.

According to various exemplary embodiments of the present disclosure, wavelengths and phases of light beams are set to be different from each other so that even though an error occurs in a light emitting element with some wavelength, the error is compensated by a light beam light emitting element with another wavelength to suppress rapid performance degradation in an operation of determining a touch coordinate of an object, thereby improving a satisfaction of a user.

According to various exemplary embodiments of the present disclosure, a touch coordinate of an object is accurately determined by means of light beams with various wavelengths and phases to improve a letter implementation performance and induce natural handwriting of the user.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a view illustrating a configuration of an electronic whiteboard according to an exemplary embodiment of the present disclosure;

FIG. 2 is a view for explaining a configuration of a touch panel according to an exemplary embodiment of the present disclosure and an operation of a light processing unit which configures the touch panel;

FIG. 3 is a view schematically illustrating a side configuration of a touch panel according to an exemplary embodiment of the present disclosure;

FIG. 4 is a view schematically illustrating a light beam which changed by an optical path converter in a touch panel according to an exemplary embodiment of the present disclosure;

FIG. 5 is a view illustrating a configuration of an optical path converter according to an exemplary embodiment of the present disclosure;

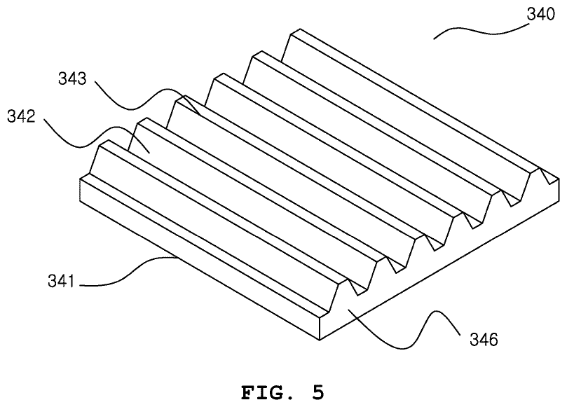

FIG. 6 is a view illustrating a configuration of an optical path converter according to another exemplary embodiment of the present disclosure; and

FIG. 7 is a flowchart of an operation of recognizing writing on an electronic whiteboard according to an exemplary embodiment of the present disclosure and displaying the writing on a screen.

### DETAILED DESCRIPTION OF THE EMBODIMENT

Hereinafter, exemplary embodiments of the present disclosure will be described with reference to the drawings. However, since the drawings accompanied in this specification serve to help understand the technical spirit of the present disclosure together with the detailed description of the present disclosure, the present disclosure should not be interpreted as being limited to the matters described in the drawings.

Further, terms used in the exemplary embodiment are used only for illustrative purposes only, but should not be interpreted as an intention to limit the scope of the present disclosure. A singular form may include a plural form if there is no clearly opposite meaning in the context. In the present specification, it should be understood that terminology “include”, “have”, “connect”, “couple”, or “connected” indicates that a feature, a number, a step, an operation, a component, a part or the combination thereof described in the specification is present, but does not exclude a possibility of presence or addition of one or more other features, numbers, steps, operations, components, parts or combinations, in advance.

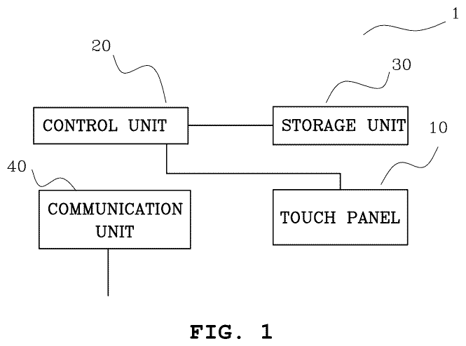

FIG. 1 is a view illustrating a configuration of an electronic whiteboard according to an exemplary embodiment of the present disclosure.

Referring to FIG. 1, an electronic whiteboard 1 includes a touch panel 10, a control unit 20, a storage unit 30, and a communication unit 40.

The control unit 20 recognizes a coordinate of an object from sensing data sensed by a light processing unit of the touch panel 10 and displays generated contents on a screen 250 based on a recognized coordinate of the object.

Further, when a user writes letters by means of the object, the control unit 20 implements the user's handwriting which is input as it is, such as a shape, a thickness, or a texture of the letters in response to the movement of the object to generate contents as letters and display the content on the screen.

When the control unit 20 identifies the touch coordinate corresponding to the user's writing and generates content based on the identified coordinate, the control unit may apply an artificial intelligence algorithm. For example, the control unit 20 applies the identified touch coordinate to a trained regression analysis algorithm as an input value to generate a shape of the content matching the writing.

When the content determined based on the identified touch coordinate is two or more connected characters, the control unit 20 inputs the identified touch coordinate and/or determined characters to a trained regression analysis algorithm as input values to determine a deleting area of the content to distinguish characters.

As described above, the control unit 20 identifies a touch coordinate of an object which is input through the touch panel 10 using the artificial intelligence algorithm and generates content based on the identified touch coordinate to improve a content implementation accuracy for the user's writing.

In addition, the control unit 20 may recognize a voice of a user which is input through a microphone (not illustrated) by means of an artificial intelligence technique (for example, speak to text (STT) or a natural language processing technique).

When the content corresponding to the coordinate is implemented based on a touch coordinate identified by the touch panel 10, the control unit 20 applies the input user voice to improve the content implementation accuracy for the user's writing.

Further, the electronic whiteboard 1 may also control peripheral devices (for example, illumination, a beam projector, or a speaker) of the electronic whiteboard 1 based on user's writing (or a content implemented based on the writing) and/or voice recognized by the artificial intelligence technique, etc. For example, the identified touch coordinate and the content implemented based thereon and/or the identified voice may include a control command to control the electronic whiteboard 1 or the related peripheral devices.

When the control unit 20 confirms the control command, the control unit 20 may perform an operation of the electronic whiteboard 1 corresponding to the control command by means of a program (app, application, tool, or plug-in, hereinafter, referred to as a data processing program) for processing the control command or may transmit data for controlling an operation of peripheral devices connected to the electronic whiteboard 1 through the communication unit 40.

Hereinafter, in various exemplary embodiments, when the electronic whiteboard 1 performs or provides data processing (or event) related to the control command, it is understood that a specified operation is performed through at least one data processing-related program of the electronic whiteboard 1.

The storage unit 30 may store various data which is processed by the control unit 20 or the communication unit 40 which is at least one component of the electronic whiteboard 1. For example, the data may include a program (or software) for processing data input through the touch panel 10, data, input data or output data about various writing generated on the data or command related thereto.

The storage unit 30 may include at least some information of coordinate information set to the screen 250, identification codes of sensing optical sensors, identification codes of light emitting elements, identification codes about a light emitting element specified to be identified for each sensing optical sensor and a light beam path therebetween, and coordinates included in each of the light beam paths, as light beam information.

In addition, the storage unit 30 may store at least some information of a light beam having a specific coordinate for at least some of coordinates of the screen 250 as a path, an identification code of a light emitting element which transmits a light beam including the specific coordinate in the path, and an identification code of a sensing optical sensor which receives a light beam including the specific coordinate in the path, a type (for example, a wavelength or a phase) and an amount of light beam emitted from each light emitting element, a light beam amount measured by the sensing optical sensor which receives a light beam in a state (initial state) in which no object is present on the screen 250, and a light beam amount measured by the sensing optical sensor which receives a light beam in a state in which an object is located in a specific coordinate on the screen 250, as light beam information.

Further, the storage unit 30 may store at least some of light beam information as a mapping table. For example, it may be stored as a mapping table to determine a coordinate matching information, such as sensing data which is measured according to a state in which an object is located on the screen, that is, a sensing optical sensor in which a change in an amount of light beam received in a specific position where an object is located occurs, a light emitting element which emits a light beam whose amount is changed, a change in a light amount for a light beam in which a light amount is changed, a position of the object, and a measured light amount.

The storage unit 30 may store information, such as at least one letter shape and a pattern in which a letter is written. For example, the storage unit may store information including Korean alphabet and English alphabet, and also store information about a shape of letters, characters, and symbols of various languages (hereinafter, referred to as letter) and also include information about a writing pattern, such as a writing order and/or a curvature of the letter.

For example, the storage unit 30 includes information about a morphological feature of a Korean alphabet “ [symbol] ” and also includes and stores information about an order of writing the letter “ [symbol] ”. In addition, the storage unit 30 includes and stores not only information about a morphological feature of a word, but also information about an order of writing the word.

The storage unit 30 may include an artificial neural network algorithm, a block chain algorithm, a deep learning algorithm, a regression analysis algorithm, and an artificial intelligence algorithm including at least some of a related mechanism, an operator, a language model, and big data to provide data processing.

For example, the storage unit 30 may include an algorithm for generating a content implemented based on a touch coordinate input through the touch panel 10 and/or an algorithm for performing an operation specified with regard to this. Further, the storage unit 30 may include an algorithm for identifying a user through a touch coordinate input through the touch panel 10 and an implemented content and/or an algorithm for performing an operation specified with regard to this.

The storage unit 30 may store various information related to the processing of a voice which is input through the microphone. For example, the storage unit 30 may include at least one algorithm for processing voice from audio input through a microphone, such as a voice recognition algorithm, a speaker recognition algorithm, or a natural language processing algorithm.

Further, the storage unit 30 may include at least one algorithm for processing a touch input through the touch panel 10, such as a touch pattern recognition algorithm, a voice linking algorithm, and a touch user distinguishing algorithm.

The storage unit 30 may include data for determining and processing control and an operation specified by a signal which is confirmed by respective devices included in the touch panel 10.

Data stored in the storage unit 30 is processed by the control unit 20 and data for processing related operations, data which is being processed, processed data, previously set data, and the like may be stored in the storage unit 30 as a database.

Data stored in the storage unit 30 may be changed, modified, deleted, or generated by the control unit 20 based on a manager input of the electronic whiteboard 1 or a user input of a user device.

The communication unit 40 may support establishment of a wired communication channel, establishment of a wireless communication channel, and performance of communication through the established communication channel, between the electronic whiteboard 1 and at least one other electronic device (for example, a user device or a server).

The communication unit 40 may operate independently or dependently from the control unit 20 and include one or more communication processors which support the wireless communication. According to the exemplary embodiment, the communication unit 40 may include a wireless communication module (for example, a cellular communication module, a short distance wireless communication module, or a global navigation satellite system (GNSS) communication module) or a wired communication module (for example, a local area network (LAN) communication module or a power line communication module).

The touch panel 10 may be configured to include a touch-input available screen. The touch panel 10 may be configured to include a light processing unit which recognizes an object approaching the touch panel and an object contacted with the screen through the light beam and a screen 250 which visually displays contents generated based on the recognized object.

The touch panel 10 may be configured as a touch screen including the light processing unit as an input unit and the screen 250 which visually displays the processed information as an output unit. Hereinafter, according to various exemplary embodiments of the present disclosure, unless otherwise specifically mentioned, the touch panel 10 is described as referring to a touch screen.

The electronic whiteboard 1 processes sensing data of an object which approaches, contacts and/or moves to the touch panel 10 through the user with the control unit 20 to recognize the writing of the user.

The control unit 20 may receive a light beam emitted from the light emitting element which configures the light processing unit of the touch panel 10 with a sensing optical sensor and determine a touch coordinate of the object located on the screen 250 and/or a distance of the object from the screen 250 based on the light beam blocked by the object located therebetween.

To this end, the touch panel 10 is configured such that two or more light beam paths intersect and may determine a touch coordinate of the object and/or a distance of the object from the screen 250 based on light beam information and a light beam amount of intersecting light beams and light beam information blocked by the object and a light beam amount.

In addition, the control unit 20 may identify an object when the object approaches in a predetermined distance from the screen 250 without being in direct contact with the screen 250 through the operation of the light processing unit which configures the touch panel 10 and perform a specified operation without being in contact with the screen 250. According to various exemplary embodiments, touch input to process a specified operation in a state in which the object is not in contact with the screen 250 may be defined as air touch.

An object used for writing on the touch panel 10 may be configured to include at least one of a part of a user's body, such as a finger or a palm to perform the touch input or a means for touch (for example, stylus or touch pen).

In addition, the electronic whiteboard 1 may further include at least some of an input unit (not illustrated) to input data, such as a keyboard or a mouse and an output unit (not illustrated) to output data, such as a speaker, a driver, or a separate screen.

According to various exemplary embodiments, the electronic whiteboard 1 or the user device may include at least some of functions in the range of all information communication devices, such as a mobile communication terminal, a multimedia terminal, a wired terminal, a fixed terminal, and internet protocol (IP) terminal.

The electronic whiteboard 1 is a device for data processing and may be configured to include at least some function of a workstation or a massive database or to be connected thereto via communication.

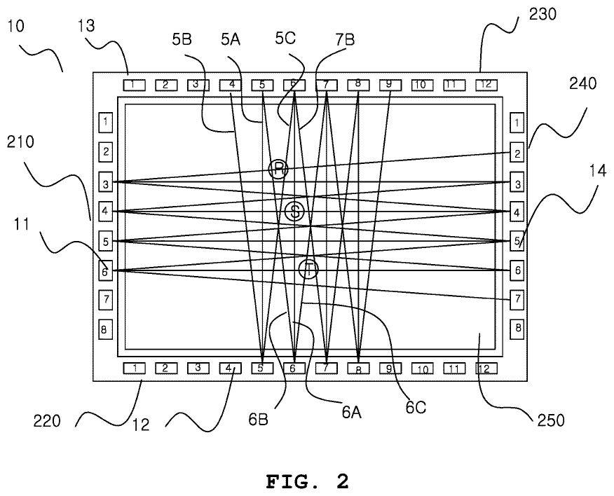

Referring to FIG. 2, the touch screen 10 may be configured to include a light processing unit and a screen 250 which visually displays a content generated based on the recognized object.

The screen 250 may be configured to include a screen panel 251 on which a written content is displayed and a protection layer 252 which is configured with a glass film or synthetic resin to protect the screen panel 251.

The light processing unit is formed inside bezels 210, 220, 230, and 240 which are edge areas of the screen 250 and may include light transmitting units 11 and 12 configured to include light beam emitting elements which generate and emit a light beam to sense an object and light receiving units 13 and 14 configured to include a sensing optical sensor which receives the light beam.

The light processing unit may be configured by a plurality of sets based on the shape of the screen and as illustrated in FIG. 2, the touch panel 10 configured with a rectangular shape may be configured to include the light processing unit configured by a total of two sets including one set 12 and 13 of upper and lower side portions and one set 11 and 14 of left and right side portions.

A first set of light processing unit (hereinafter, first light processing unit) configured on the top and bottom side portions of the touch panel 10 may be configured by a first light transmitting unit 12 on a lower bezel of the screen 250 and a first light receiving unit 13 on an upper bezel of the screen 250.

Further, a second set of light processing unit (hereinafter, second light processing unit) configured on the left and right side portions of the touch panel 10 may be configured by a second light transmitting unit 11 on a left bezel of the screen 250 and a second light receiving unit 14 on a right bezel of the screen 250.

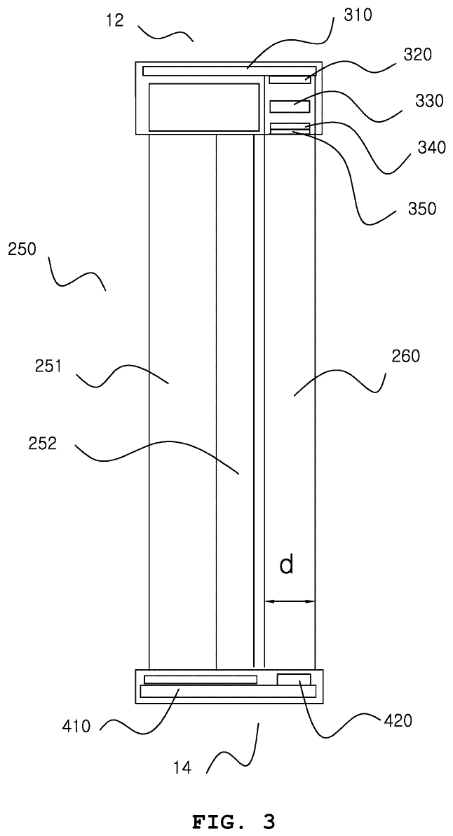

FIG. 3 is a view schematically illustrating a left cross-section by cutting the touch panel 10 of FIG. 2 from the top to the bottom.

The first light transmitting unit 12 of the touch panel 10 may be configured to include a PCB 310 and at least one light emitting element mounted in the PCB 310.

Here, the PCB 310 is disposed to be perpendicular to the screen 250 in the first bezel 210. Further, the first bezel 210 may be disposed to be in contact with a side surface of the screen 250 and a part thereof may be disposed to protrude upwardly from the screen 250. The light emitting element may be attached to a portion located higher than the screen 250 in the light transmitting unit PCB 310 to be horizontal with the screen 250.

An optical filter 330 which filters a wavelength of the light beam may be installed on a front surface portion of the light emitting element. The optical filter 330 may filter a wavelength of light beam which is emitted from the light emitting element to be incident onto the optical filter 330. For example, the optical filter 330 may remove a part of light corresponding to a wavelength other than an infrared area, among light beams incident onto the optical filter 330. For example, a light beam passing through the optical filter 330 may have a higher infrared ratio than a light beam incident onto the optical filter 330.

An optical path converter 340 which converts a direction of light beam emitted from the light emitting element or the optical filter 330 is installed on the front surface portion of the optical filter 330.

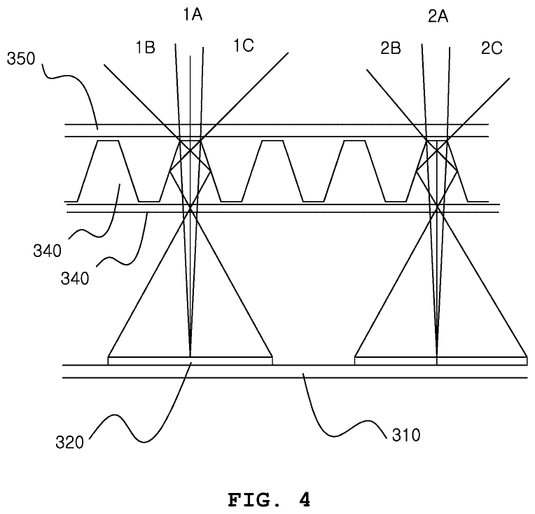

As illustrated in FIG. 4, the optical path converter 340 is a prism sheet in which a support film 341 and a trapezoidal prism pattern 342 formed on the support film 341 are formed and is attached onto a surface of a transparent support 350 which is formed as a transparent glass to seal the light transmitting unit and convert a direction of a light beam emitted from the light emitting element to a predetermined direction.

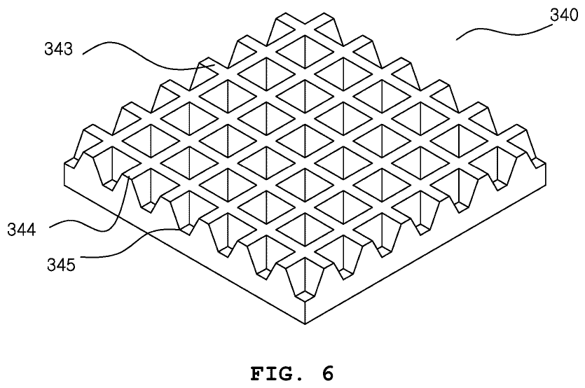

As illustrated in FIG. 6, the optical path converter 340 may be a laminated prism sheet with a double-layered structure in which an upper prism sheet having a first pattern in a first direction on one surface and a lower prism sheet having a second pattern in a second direction on one surface are coupled with an adhesive layer therebetween.

Further, as illustrated in FIG. 6, an upper prism sheet having a first pattern of a first direction on one surface and a lower prism sheet having a second pattern of a second direction on one surface are overlaid to form a hybrid prism sheet with a hybrid structure having a plurality of quadrangular patterns with trapezoidal surfaces and the first direction and the second direction are different directions and may be perpendicular to each other.

The prism pattern 342 may be manufactured by applying an UV curable resin solution resin to one surface of a support film which is formed of at least one of polyethylene terephthalate or polyethylene naphthalate, which is a transparent material to transmit light and irradiating light to cure the resin.

In the prism sheet configured as described above, a larger trapezoidal surface 346 is disposed to be closer to the light emitting element and a smaller surface 345 is disposed at the outside and a pitch of the prism pattern 342 is formed to be 0.5 times or less than a length of the light emitting element to decompose light beam emitted from one light emitting element into a set of a plurality of light beams. The decomposed light beams are divided into a set of light beams similar to a direction perpendicular to the prism, a set of light beams similar to a direction reflected by a left surface of the prism, and a set of light beams similar to a direction reflected by a right surface of the prism.

A light energy of the set of light beams similar to the direction reflected by the trapezoidal surface of the prism pattern is smaller than a light energy of a set of light beams similar to the direction perpendicular to the prism. A thin light absorption film may be formed on an inclined surface of the trapezoidal surface of the prism pattern. When the light absorption film is formed, the light energy of the set of the light beams similar to the direction reflected by the trapezoidal surface of the prism pattern is further reduced to allow the light receiving unit to more accurately sense the position of the object as it will be described below.

As illustrated in FIG. 3, the first light receiving unit 400 may be configured to include a light receiving unit PCB 410 and at least one sensing optical sensor 420 mounted in the light receiving unit PCB 323.

Here, the light receiving unit PCB 410 may be disposed to be perpendicular to the screen 250 in the second bezel 303. Further, the second bezel 303 may be disposed to be in contact with a side surface of the screen 250 and a part thereof may be disposed to protrude upwardly from the screen 250. The sensing optical sensor 420 may be attached to a portion located higher than the screen 250 in the light receiving unit PCB 410 to be horizontal with the screen 250.

Here, the sensing optical sensor 420 for identifying various directions may be configured to identify a light beam direction in various ranges in one sensing optical sensor or may be configured to include a plurality of sensing optical sensors which identifies light beam directions in different ranges or partially overlapping ranges, for example, a sensing optical sensor in a first direction range, a sensing optical sensor in a second direction range, and a sensing optical sensor in a third direction range. At this time, when the plurality of sensing optical sensors is included, the plurality of sensing optical sensors may be configured as one module.

The electronic whiteboard 1 configured as described above operates as follows.

First, referring to FIG. 4, a light beam which is emitted from one light emitting element to be incident onto a larger surface 346 of a lower trapezoid of the optical path converter 340 may be divided into a light beam set A (5A and 6A) which passes through a smaller surface 345 of an upper trapezoid without being reflected, a light beam set B (5B and 6B) which is reflected from a right inclined surface of the trapezoid to pass through the smaller surface 345, and a light beam set C (5C and 6C) which is reflected from a left inclined surface of the trapezoid to pass through the smaller surface 345. Here, the light beam set A is not reflected from the reflection surface, but travels straight so that it has a higher energy level than the light beam sets B and C having a reflection path and has a phase difference.

In the meantime, the light beam sets A, B, and C are configured to be received and identified by the plurality of sensing optical sensors.

Referring to FIG. 2, a light beam emitted from a sixth light emitting element of the first light transmitting unit 12 may be configured to be identified by fifth, sixth, and seventh sensing optical sensors of the light receiving unit 13.

Further, an amount of light beams received by respective sensing optical sensors may vary depending on the positions R, S, and T of the object. For example, when the object is in the position of R, a fifth sensing optical sensor receives a light beam 5A, when the object is in the position of S, the fifth sensing optical sensor receives light beams 5A and 6B, and when the object is in the position of T, the fifth sensing optical sensor receives light beams 5A and 6B.

Further, when the object is in the position of R, a sixth sensing optical sensor receives light beams 6A and 7B, when the object is in the position of S, the sixth sensing optical sensor receives light beams 7B and 6C, and when the object is in the position of T, the sixth sensing optical sensor receives light beams 5C and 7B.

The control unit 20 may calculate an amount of light beams received by the plurality of sensing optical sensors as compared with an amount of light beam emitted from individual light emitting elements according to a type and a position of the object, store the amount in the storage unit, and determine a touch coordinate of the object and/or the distance of the object from the screen 250 based on the amount, by the artificial intelligence.

Referring to FIG. 2, light amounts received by the fifth, sixth, seventh, and eighth sensing optical sensors after converting the light beam in the light converter as compared with the amount of light emitted from the sixth light emitting element in an initial state (a state in which there is no object) is stored in the storage unit and light amounts received by the fifth, sixth, seventh, and eighth sensing optical sensors after converting the light beam in the light converter as compared with the amount of light emitted from the sixth light emitting element according to the type and the position of the object in a state in which an object is present is calculated to determine the touch coordinate of the object and/or a distance of the object from the screen 250.

Further, when two or more light emitting elements are formed as a group, a change in the light amount is calculated by two or more light emitting elements and a plurality of sensing optical sensors corresponding thereto to determine the touch coordinate of the object and/or a distance of the object from the screen 250.

As described above, the touch panel 10 determines a position of an object using a plurality of light beams emitted from one light emitting element or a group of two or more light emitting elements, rather than determining a position of an object with one light emitting element and one sensing optical sensor, to not only precisely determine a touch coordinate of the object, but also precisely and accurately identify a touch position according to a movement of an object.

Referring to the second light processing unit, a light beam emitted from one light emitting element may be configured by one to one to be received and identified by one sensing optical sensor. Accordingly, in various exemplary embodiments, a light beam path between a first light emitting element of the second light processing unit and the first sensing optical sensor may be defined as a first light beam path and a light beam path between a second light emitting element of the second light processing unit and the second sensing optical sensor may be defined as a second light beam path.

However, the present disclosure is not limited thereto and the second light processing unit may also be configured to receive and identify a light beam emitted from one light emitting element by a plurality of sensing optical sensors, like the first light processing unit.

As described above, one sensing optical sensor which configures the first light processing unit may identify a light beam emitted from a plurality of light emitting elements based on a configuration and setting information.

The control unit 20 may determine a coordinate where the object is located based on light beam information of a coordinate where the object is located in the screen 250 and object sensing data of the light processing unit and determine a distance of the object from the screen 250.

Here, with regard to the light beam information of the coordinate where the object is located in the screen 250, the storage unit 30 of the electronic whiteboard 1 may include at least some information of coordinate information set to the screen 250, an identification code of each sensing optical sensor, an identification code for a light emitting element specified to be identified for each sensing optical sensor, and a light beam path therebetween, and coordinates included in the respective light beam paths, as light beam information.

Here, as illustrated in FIG. 2, the light beam path may be determined as an area including a plurality of coordinates based on a light beam wavelength and a light beam amount and at this time, a weight for a position accuracy may be applied based on a distance from a center line of the path.

In addition, the light beam information may further include at least some information of a light beam having a specific coordinate for each coordinate set to the screen 250 as a path, an identification code of a light emitting element which transmits a light beam having a coordinate as path, and an identification code of a sensing optical sensor which receives a light beam, a type (for example, a wavelength or a phase) and an amount of light beam emitted from each light emitting element, a light beam amount measured by the sensing optical sensor which receives a light beam in a state (initial state) in which no object is present on the screen 250, and a light beam amount measured by the sensing optical sensor which receives a light beam in a state which an object is located in a specific coordinate on the screen 250.

The light beam information may store information such as sensing data which is measured according to a state in which an object is located on the screen 250, that is, a sensing optical sensor in which a change in an amount of light beam received in a specific position where an object is located occurs, a light emitting element which emits a light beam whose amount is changed, a change of a light beam amount for a light beam in which a light beam amount is changed, and a measured beam amount before/after a position of the object, as a mapping table.

The object sensing data of the light processing unit may include light beam measurement data measured by individual sensing optical sensors of the touch panel 10 in a state where the object is located in a specific position of the screen 250 and light beam measurement data may include information related to a light beam having a plurality of wavelengths measured by individual sensing optical sensors and a light amount.

The control unit 20 may identify a wavelength of a light beam in which a light beam amount is changed and a change in the light amount based on the light beam information and the object sensing data and identify a light emitting element which emits changed light beam, and extract a coordinate based on the identified information and the mapping table.

The control unit 20 may accurately determine a position of the object by confirming that a ratio of light beams with various wavelengths which are changed in response to a fine movement of the object generated in the screen 250 is also minutely changed, a light beam with a new wavelength which is changed is additionally confirmed, and/or a light beam with a specific wavelength which has been changed returns to an initial state.

If the position of the coordinate is determined according to a ratio of various light beams which are confirmed to be changed for a coordinate on which the object is located on the screen 250, the control unit 20 may determine a distance of the object from the screen 250 based on light amounts (or a variance of a light amount) of various light beams which are confirmed to be changed.

When the letters are written on the screen of the touch panel 10 by means of the object based on the touch panel 10 with the above-described configuration, the control unit 20 identifies a coordinate in which the object is located and a moving coordinate and recognizes a shape of the written letters and an order of writing the letters based on the identified coordinate and the movement of the coordinate to determine which letter is written. The control unit 20 implements the determined letter as the written letter to be the same or similar to be displayed on the screen 250.

The purpose of precisely and accurately implementing user's writing through the touch panel 10 of the electronic whiteboard 1 according to various exemplary embodiments is to implement user's writing characteristics, such as a form of letters and/or shapes, a change in a writing feeling according to the user's strength and weakness, and a characteristic of the handwriting as it is to be displayed on the screen 250.

Further, the control unit 20 implements the user's writing to analyze shapes of a current letter and an adjacent letter among letters of the content displayed on the screen 250 and when at least some of the letter and the adjacent letter are not clearly identified, may control to clearly display adjacent letters by adjusting a thickness of the letter displayed on the screen 250 by referring to a shape of the letter and the writing pattern stored in the database and deleting a part which is unnecessarily connected between adjacent letters.

In addition, the control unit 20 determines that the user starts the writing while the object is spaced apart from the screen 250 by a predetermined distance without being in contact with the screen of the touch panel 10 and when a letter which is written by the air-touch is implemented, the letter may be implemented with an unnecessary part which is connected between the letters.

At this time, the control unit 20 may remove the unnecessary part connected between the letters, based on a letter confirmed from the database based on the implemented letter and a shape of the implemented letter.

The control unit 20 may determine and delete unnecessary parts of letters by comparing at least some conditions among the shapes of letters, strokes, and stroke ratios confirmed through the database with letters that have been implemented, and then output them on the screen 250.

In addition, the control unit 20 may adjust a height d (or a thickness) of an air touch layer based on a light beam amount in an initial state which is emitted through the light transmitting unit of the touch panel 10, for example, a light beam amount emitted from each light emitting element included in the light transmitting unit and/or a light reception sensitivity of the light receiving unit to determine an air touch of the object and the writing.

According to the exemplary embodiment, the control unit 20 may determine the writing of the user at the time when the air touch starts and control a point and/or line to be implemented, that is, the thickness of the letters to be thick, according to the degree to which object is close to the screen 250.

That is, when the user writes letters while contacting the object to the screen 250, the content may be implemented with a thickness which is confirmed at a time when the object is in contact with the screen 250 as a maximum thickness of the letter. At this time, the control unit 20 may adjust the maximum thickness of the letter (or a thickness of stroke) when the written letter is implemented by adjusting a height d of the air touch layer.

According to the exemplary embodiment, the light reception sensitivity of the light receiving unit is about the variance of the light beam amount to determine that the air touch of the object starts, with respect to the light beam amount in the initial state and is determined according to the value of the light reception sensitivity. The control unit 20 processes the light amount measured by the sensing optical sensor to determine the air touch start point according to the light reception sensitivity.

For example, when the light reception sensitivity is set to 10%, the control unit 20 confirms that the closer the object to the screen 250, the smaller the light beam amount in the initial state measured by the sensing optical sensor and when it is confirmed that it is reduced by 10% of the light beam amount of the initial state, may determine that the air touch starts.

At this time, an area from the position in the space on the screen where the air touch starts to the surface of the screen 250 may be defined as the air touch layer. The control unit 20 may control the height d of the air touch layer by controlling the light beam amount emitted from the light emitting elements in the initial state and/or the light reception sensitivity of the sensing optical sensor.

The control unit 20 controls the height d of the air touch layer to control the thickness of the content implemented as illustrated in FIG. 4B or 4C. When the height d of the air touch layer is controlled and the thickness of the written content is controlled, the control unit 20 may control the thickness of the content which has been already implemented.

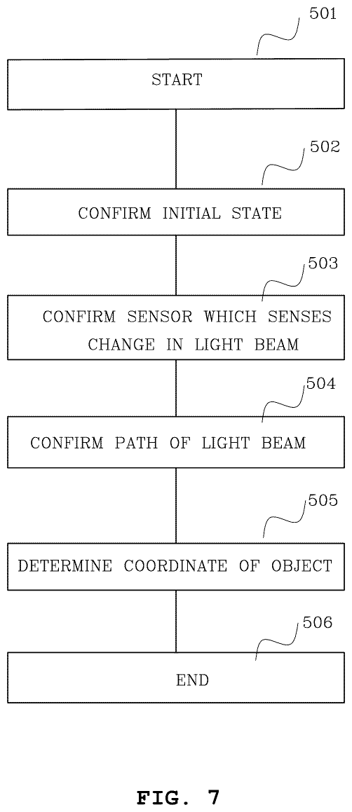

FIG. 7 is a flowchart of an operation of recognizing a writing on an electronic whiteboard according to an exemplary embodiment of the present disclosure and displaying the writing on a screen.

A light transmitting unit of the touch panel 10 of the electronic whiteboard for light beam touch is configured to emit two or more light beam directions having different paths and a light receiving unit receives light beams with different directions and may more accurately and precisely determine the position and the movement of the object using the identified light beam.

Hereinafter, an operation of displaying the writing on the screen 250 by implementing a position of the object and a writing content through a light beam in the electronic whiteboard 1 will be described in detail by means of steps of FIG. 7.

In step 501, the electronic whiteboard 1 confirms light beam sensing data from which a light beam amount is measured as an initial state in which an object is not sensed, by means of a plurality of sensing optical sensors configured to identify at least two types of light beams.

All the plurality of light emitting elements included in the light transmitting unit may be set to emit light beams with a predetermined brightness or set to emit light beams with different brightness according to the feature of the light emitting elements.

The database of the electronic whiteboard 1 may include information about an identification code of each light emitting element, a type of light beam emitted from each light emitting element, and an identification code of a sensing optical sensor specified to receive a light beam emitted from each light emitting element.

The electronic whiteboard 1 may identify a type of light beam received by each sensing optical sensor, identify a light emitting element which emits a light beam based on the database, record a brightness set to be emitted from the light emitting element and a brightness received by the sensing optical sensor, and generate sensing data in an initial state of the touch panel 10 based thereon.

The electronic whiteboard 1 may be set to update sensing data in the initial state at a time when it is confirmed that the object recognized on the touch panel 10 is removed or at a predetermined time interval.

For example, when the electronic whiteboard 1 confirms that the light beam amount emitted from a specific light emitting element is reduced during the operation of updating sensing data in the initial state, the electronic whiteboard 1 may control a light reception sensitivity of a sensing optical sensor which receives the light beam based thereon. At this time, the electronic whiteboard 1 may adjust a light reception sensitivity for the light emitting element which emits the light beam.

In step 503, when the electronic whiteboard 1 confirms a change in a light amount from at least a part of the light beam amount in the initial state based on a value of the light beam sensing data, the electronic whiteboard 1 checks two or more sensing optical sensors which sense the change in the light amount.

When the change in the light beam amount is confirmed while maintaining the sensing data in the initial state, the electronic whiteboard 1 may confirm the sensing optical sensors which sense the change in the light amount and determine air touch of the object based on the change in the light beam amount and determine that the user's writing starts.

For example, when a light amount of the light beam received by the sensing optical sensor is reduced to be a predetermined light amount or less based on the set light reception sensitivity, the electronic whiteboard 1 may determine that the object approaches the screen 250 and determine that the user's writing starts.

For example, when an average light amount of light beams whose amount is changed, among light beams received by at least one sensing optical sensor, is reduced to a predetermined value, or a ratio of light beams whose light amount is changed, among light beams received by at least one sensing optical sensor, satisfies a specific value, the electronic whiteboard 1 may determine that the user's writing starts.

In step 504, the electronic whiteboard 1 confirms two or more different types of light beams identified by two or more sensing optical sensors and paths of the light beams.

The electronic whiteboard 1 may identify a type of light beam whose light amount is changed from each sensing optical sensor which confirms the change in the light beam amount and confirms a light emitting element which emits the corresponding light beam based on the identified light beam type.

The electronic whiteboard 1 may confirm a light beam path between the confirmed light emitting elements and the sensing optical sensor. The electronic whiteboard 1 may confirm a light beam path of a light beam whose amount is changed with respect to all the plurality of sensing optical sensors which confirms the change in the light beam amount.

In step 507, the electronic whiteboard 1 determines a touch coordinate touched by the object, among coordinates in an area where paths of two or more different types of light beams intersect and an area where the paths intersect based on the variance of the light beam amount.

The electronic whiteboard 1 may confirm a coordinate of an area where paths of the light beams confirmed that the light amount is changed intersect. At this time, when a size of the area where the paths of the light beams intersect or the number of coordinates included in the area is larger than a predetermined number, light beams whose amount is changed are sorted in the order of larger change in the light amount and a touch coordinate of the object is determined by giving a priority to coordinates in the area where paths of the light beams having a larger change in the light amount intersect. A plurality of touch coordinates may be determined by coordinates included in an area with a specified size or within a predetermined number of coordinates.

For example, when a size of the area where the paths of the light beams intersect is larger than a size of a unit area (for example, a point or a thickness of a letter) for the thickness of a letter implemented for the touch coordinate, the electronic whiteboard 1 resets an area to determine a touch coordinate of an object with respect to an intersecting area of the light beam path having a higher priority to control the size of the area where the paths of the light beams intersect.

When the touch coordinate of the object is determined, the electronic whiteboard 1 may compare confirmed information, such as an identification code of a sensing optical sensor which receives a light beam with a changed light amount, an identification code of a light emitting element which emits light beam, a light beam path therebetween, an area where the light beam paths intersect, a light amount variance of light beams whose light amount is changed, a light beam priority according to the light amount variance with the mapping table of the database and may determine the matching touch coordinate as a touch coordinate of the object.

The electronic whiteboard 1 performs the operation of step 507 to end the operation of FIG. 7.

According to the detailed description of the present disclosure, functions of various exemplary embodiments which have been described to be performed by the electronic whiteboard 1 are operations to be processed by the control unit 20 of the electronic whiteboard 1 and may be performed by being organically connected to the components of the electronic whiteboard 1.

Although the exemplary embodiments have been described above with limited drawings, it should be noted that other implementations, other embodiments, and equivalents to the claims are also within the scope of the claims to be described below.

What is claimed is:

1. An electronic whiteboard with an improved writing recognition performance, comprising:
a light processing unit which recognizes a coordinate of an object from sensed sensing data; and
a screen which visually displays a content generated based on the recognized coordinate of the object,
wherein the light processing unit includes: a light transmitting unit including a plurality of light emitting elements installed on a screen; and a light receiving unit including a plurality of sensing optical sensors which is installed in a position corresponding to the light transmitting unit to receive a light beam emitted from the light emitting elements,
the light transmitting unit includes: the light emitting element which emits the light beam and an optical path converter which is installed on a front surface portion of the light emitting element to convert a direction of the light beam emitted from the light emitting element, and
the optical path converter is a prism sheet in which a trapezoidal prism pattern is formed and converts the direction of the light beam emitted from the light emitting element to a plurality of directions.

2. The electronic whiteboard with an improved writing recognition performance according to claim 1, wherein the prism pattern includes a support film and a larger surface of the trapezoid is disposed to be closer to the light emitting element and a smaller surface is disposed at the outside.

3. The electronic whiteboard with an improved writing recognition performance according to claim 2, wherein a pitch of the prism pattern is 0.5 times or less than a length of the light emitting element.

4. The electronic whiteboard with an improved writing recognition performance according to claim 2, wherein an inclined surface of the trapezoid of the prism pattern is 45° to 60°.

5. The electronic whiteboard with an improved writing recognition performance according to claim 1, wherein the optical path converter is attached onto a surface of a transparent support.

6. The electronic whiteboard with an improved writing recognition performance according to claim 2, wherein a thin light absorption film is formed on an inclined surface of a trapezoidal side surface of the prism pattern.

7. The electronic whiteboard with an improved writing recognition performance according to claim 1, wherein the optical path converter is a laminated prism sheet with a double-layered structure in which an upper prism sheet having a first pattern in a first direction on one surface and a lower prism sheet having a second pattern in a second direction on one surface are coupled with an adhesive layer therebetween.

8. The electronic whiteboard with an improved writing recognition performance according to claim 1, wherein the optical path converter is a hybrid prism sheet with a hybrid structure in which an upper prism sheet having a first pattern in a first direction on one surface and a lower prism sheet having a second pattern in a second direction on one surface are overlaid to have a plurality of patterns with quadrangular shapes with trapezoidal surfaces.

9. The electronic whiteboard with an improved writing recognition performance according to claim 7, wherein the first direction and the second direction are different directions and the two directions are perpendicular to each other.

10. The electronic whiteboard with an improved writing recognition performance according to claim 1, wherein the prism pattern is formed by applying an UV curable resin solution resin to one surface of a support film which is formed of at least one of polyethylene terephthalate or polyethylene naphthalate, which is a transparent material to transmit light and irradiating light to cure the resin.

11. The electronic whiteboard with an improved writing recognition performance according to claim 1, wherein the light transmitting unit includes an optical filter which filters a direction of the light beam.

12. The electronic whiteboard with an improved writing recognition performance according to claim 8, wherein the first direction and the second direction are different directions and the two directions are perpendicular to each other.
